(19) United States
(12) Patent Application Publication
(10) Pub. No.: US 2024/0107196 A1
(43) Pub. Date: Mar. 28, 2024

(54) OPTICAL SENSOR AND ELECTRONIC DEVICE INCLUDING THE SAME

(71) Applicant: ams Sensors Belgium BVBA, BERCHEM (BE)

(72) Inventor: Dong-Long LIN, ANTWERPEN (BE)

(73) Assignee: ams Sensors Belgium BVBA, BERCHEM (BE)

(21) Appl. No.: 18/257,114

(22) PCT Filed: Dec. 14, 2021
(86) PCT No.: PCT/EP2021/085694

§ 371 Date: Jun. 13, 2023

(30) Foreign Application Priority Data
Dec. 15, 2020 (DE) 10 2020 133 510.5

(51) Int. Cl. H04N 25/771; H04N 25/707; H04N 25/708

(52) U.S. Cl. CPC H04N 25/771; H04N 25/707; H04N 25/708

(57) ABSTRACT

An optical sensor includes an array of pixels, wherein each pixel includes a photodiode configured to receive an optical signal and a floating node coupled to the photodiode. At least one sensing path is capacitively coupled to the floating node of at least one of the pixels. An evaluation unit is coupled to the at least one sensing path to generate an electrical signal dependent on the optical signal received by the photodiode.

### CROSS-REFERENCE TO RELATED APPLICATIONS

This patent application is the national stage entry of International Patent Application No. PCT/EP2021/085694, filed on Dec. 14, 2021, and published as WO 2022/129051 A1 on Jun. 23, 2022, which claims priority to German patent application 102020133510.5 filed on Dec. 15, 2020, the disclosures of all which are hereby incorporated by reference.

### TECHNICAL FIELD

The present disclosure relates to an optical sensor. Specifically, the present disclosure relates to an optical sensor that includes an array of pixels including a photodiode and a floating node. The present disclosure also relates to an electronic device that includes an optical sensor to perform electronic functions.

### BACKGROUND

Optical sensors are widely used in electronic devices to capture optical signals such as an optical image and treat the image information for display or other purposes. The image sensor comprises a plurality of pixels arranged in an array having rows and columns. The image information may be captured in a rolling shutter mode in which a scanning over the array is performed in a rolling or consecutive manner or in a global shutter mode in which a snapshot across the array is taken at one time instance.

An image sensor may also perform tasks that require only a portion of the information of the image or a lower resolution of the image contents or an average of the information across the image. Such functions may include the wakeup of the image sensor and/or the device that includes the image sensor after the detection of a light change, the detection of a moving object such as the operation of the electronic device by gesture control, a counting operation in an industrial environment, the enhancement of the image contents in response to edge detection or other functions. Another application of an image sensor may be in the field of optical data transmission wherein the image sensor determines the reception of a light signal which is modulated with data such as a standardized LiFi (light fidelity) transmission. For at least some of the above-mentioned applications, conventional electronic devices include a separate, dedicated sensor element or perform a filtering of the full resolution image, although these functions require only the determination of a rough light change or a change in portions of the image.

Therefore, there is a need for a new readout scheme for an optical sensor that can perform one of the above-mentioned functions more efficiently.

It is an object of the present disclosure to provide a readout scheme for an optical sensor.

It is another object of the present disclosure to provide an electronic device that performs electronic functions based on an optical sensor.

### SUMMARY

One or more of the above-mentioned objects are resolved by an optical sensor according to the features of present claim 1.

According to an embodiment, an optical sensor comprises an array of pixels. Each pixel represents a subunit of the optical sensor and includes at least a photodiode which is configured to receive an optical signal and circuitry to access and read out the contents of the pixel generated by the reception of the optical signal. The pixel includes a floating node which is coupled to the photodiode through an access transistor. When the access transistor is enabled, the floating node is coupled to the photodiode and stores a charge representative of the photocurrent and therefore representative of the received amount of light. The pixels may be arranged in array form in rows and columns so that corresponding selection circuits can access each pixel during conventional readout.

At least one sensing path is capacitively coupled to the floating node of the at least one pixel of the pixel array. The capacitive coupling of the extra sensing path to the floating node is non-destructive to the signal generated by the photodiode so that additional readout of the pixel information through the conventional readout circuitry is possible. The pixel is configured to couple a voltage change at the floating node to the extra sensing path. A voltage change at the floating node is capacitively coupled to the extra sensing path and the voltage change obtained through the extra sensing is proportional to the information in the pixel. For most applications considered herein it is sufficient to compare the information sensed with the extra sensing path with a threshold rather than using the full dynamic range of the signal provided by the photodiode. It may be possible to operate the sensor with a reduced voltage lower than the normal operating voltage. The circuits comparing the extra sensing path with a comparison threshold may also operate at low voltage such as a low voltage comparator.

An evaluation unit is coupled to the at least one sensing path and generates an electrical signal which depends on the optical signal received by the photodiode to perform additional functions such as wakeup, gesture detection, edge detection etc.

The at least one pixel comprises an access transistor which is coupled between the photodiode and the floating node. The access transistor comprises a diffusion region disposed in a semiconductor substrate such as a drain or source region and a metal line in a wiring layer disposed on the substrate which is connected to the diffusion region. The extra sensing path is capacitively coupled to the metal line connected to the diffusion region of the access transistor so that a voltage change occurring at the floating node when the access transistor is enabled couples to the metal line.

According to an embodiment, the extra sensing path may comprise another metal line which is disposed in the vicinity of the metal line connected to the diffusion region of the access transistor so that a capacitive coupling is achieved between the two metal lines that enables non-destructive readout through the extra sensing path.

According to an embodiment, the optical sensor is an image sensor that comprises a semiconductor substrate which includes the photodiodes of the pixels of the array of pixels in a matrix arrangement such as rows and columns. A wiring layer is disposed in a dielectric material which is disposed on a surface of the semiconductor substrate. Optical light will be received at the back side of the semiconductor substrate that is the surface opposite that surface that carries the dielectric layer arrangement including the wiring layer. The wiring layer comprises the metal line connected to the diffusion region of the access transistor and the other metal line of the extra sensing path. The metal line and the other metal line are arranged at the same height above the surface of the semiconductor substrate horizontally within the same wiring layer. A vertical arrangement that includes the metal line connected to the diffusion region of the access transistor and the other metal line for the extra signal sensing path disposed in wiring layers disposed at different height in the dielectric layer stack may also be possible. The distance between metal line and extra metal line is such that good capacitive coupling is achieved.

According to an embodiment, a distance between the metal line and the other metal line may be in a range of less than 150 nm or less than 110 nm which may apply to a manufacturing process that uses structures in the semiconductor substrate having a diameter or a dimension of 110 nm. The distance between the metal line and the other metal line may be even less than 90 nm depending on the capabilities of the manufacturing process.

According to an embodiment, a plurality of pixels may exhibit a respective extra sensing path and all the extra sensing paths connected to the plurality of pixels may be coupled to each other to generate a combined electrical sensing signal. The combination may be a wiring of the extra sensing paths lines all together so that an average electrical signal is generated which depends on the optical signals received by the photodiodes of the plurality of pixels. The plurality of combined sensor paths may be made throughout the pixel array so that a global sensing output signal is generated. Other embodiments may use a coupling of a subset of pixels or several subsets of pixels from the array to generate one or more locally combined extra sensing paths. The regions that include the pixels that have combined extra sensing paths may be continuous, non-overlapping regions so that several local extra sensing paths from several non-overlapping regions of pixels from the array may be generated. Global extra sensing paths use optical information received throughout the full pixel array, for example, for wakeup detection or LiFi applications or the counting of objects. Local extra sensing paths of several different non-overlapping regions allow applications such as movement detection including multi-dimensional movement and gesture detection.

According to an embodiment, the array of pixels may comprise at least two groups of pixels disposed in non-overlapping regions so that at least one sensing path is coupled to the photodiode of a pixel of the first group and another sensing path is coupled to the photodiode of a pixel of a second group of pixels. This allows edge detection when the extra sensing paths can be intermediately stored in a stacked arrangement. If a plurality of extra sensing paths are combined to a local sensing path within each one of the first and second groups of pixels, movement or gesture detection is possible. Edge detection may be useful to run an image enhancement algorithm using the information from the extra sensing paths. As the edge detection information is received through the capacitive coupling to the floating nodes of the pixels, the edge detection input to the enhancement algorithm is non-destructive to the image information.

According to an embodiment, the array of pixels may be divided into several, non-overlapping regions each including a group of pixels. The regions may be arranged such that a first group of pixels is disposed in a central location of the optical sensor and has a rectangular shape. The other second, third, fourth and fifth groups of pixels are arranged in non-overlapping regions outside the first, central group of pixels. For example, the second through fifth groups of pixels may each have a rectangular shape so that the image of those groups of pixels is disposed opposite one of the edges of the first, central group of pixels. Edges of the second through fifth group of pixels may be parallel to an edge of the central first group of pixels. Each of the first through fifth group of pixels may include sensing paths from the pixels therein combined to at least one local sensing path representative of the average light information from the corresponding region of the array so that the pixel array generates, in this case, five local light signals from non-overlapping separate regions disposed within the pixel array. This allows movement detection including multi-dimensional movements wherein the movement by an object or the hand of a human operator is detected through capacitive coupling non-destructively so that a corresponding action can be performed without destroying the image content.

The extra sensing path concept according to the principles of this disclosure can be applied to an optical image sensor configured for rolling shutter operation as well as an optical image sensor configured for global shutter operation. According to an embodiment, the rolling shutter and global shutter pixels may include a source follower transistor having a gate terminal connected to the floating node, a column selection transistor coupled between the source follower transistor and a readout line. A plurality of readout lines are connected to a selection circuit such as a column detector to provide the electrical signal from the readout lines to an output terminal of the optical sensor which provides the optical image information external to the image sensor for further processing of the image information. The extra sensing path or extra sensing paths are globally or locally provided in addition to this traditional readout scheme.

According to an embodiment, the evaluation unit that receives the extra sensing path of at least one pixel may comprise a comparator to compare the electrical signal from the extra sensing path with a threshold signal. This detects an environmental light change that can be used for wakeup to trigger a startup process and bring the array of pixels from a standby state to a power-up state without destroying the information within the pixel.

The comparator may be a low voltage comparator and the pixel array may be operated at reduced supply voltage. After start-up, the optical sensor is operated at higher normal supply voltage and may process the high quality picture information. In a security application, a high quality image can be immediately taken after start-up.

According to another embodiment, the optical signal received by the optical image sensor may include a stream of digital data. The evaluation unit may comprise an analog-to-digital converter to convert the electrical signal to a digital signal and further comprise a data separation unit to retrieve the digital data from the digitally converted signal and provide the obtained digital data for further processing. The data separation unit may be realized as a data processor. The full array is available for optical signal data reception. The optical signal as well as the digital circuit for its evaluation may apply to the LiFi (light fidelity) standard.

According to another embodiment, edge detection may be performed from at least one sensing path coupled to a first group of pixels and another sensing path coupled to a second group of pixels. Edge detection further requires additional circuitry such as memory for stacking image information.

According to yet another embodiment, the optical sensor may comprise first through fifth groups of pixels wherein the evaluation unit receives sensing paths provided by each one of the first through fifth groups of pixels to perform movement or gesture detection.

An electronic device includes the optical sensor described above and at least a processor which is configured by software to perform tasks such as performing wakeup or recording a high quality image in response to the detection of a light change by the optical sensor through the extra sensing path, performing an action of the electronic device in response to a gesture detection by the extra sensing path of the optical sensor or a counting operation in an industrial environment in response to a movement detection by the optical sensor, the retrieval of data from a stream of data received by the optical sensor for a LiFi application and/or the enhancement of the contents of an image in response to an edge detection performed by the optical sensor. All these applications can be performed in a non-destructive manner so that the high quality image information captured is available for processing in response to one of said tasks.

It is to be understood that both the foregoing general description and the following detailed description are merely exemplary, and are intended to provide an overview or framework to understand the nature and character of the claims. The accompanying drawings are included to provide a further understanding and are incorporated in, and constitute a part of, this description. The drawings illustrate one or more embodiments, and together with the description serve to explain principles and operation of the various embodiments.

The same elements in different figures of the drawings are denoted by the same reference signs.

### BRIEF DESCRIPTION OF THE DRAWINGS

In the drawings:

FIG. 1 shows a rolling shutter pixel including an extra sensing path;

FIG. 2 shows a global shutter pixel including an extra sensing path;

FIG. 3 shows a cross-section through a portion of the pixels shown in FIGS. 1 and 2;

FIG. 4 shows the application of a pixel with an extra sensing path in a security application;

FIG. 5 shows the application of a pixel with an extra sensing path in a LiFi application;

FIG. 6 shows applications of a pixel with an extra sensing path;

FIG. 7 shows a local light sensing arrangement;

FIG. 8 shows pixels with extra sensing paths for edge detection;

FIG. 9 shows signals from the circuits in FIGS. 1 and 2 to read out the extra sensing path; and

FIG. 10 shows an electronic device including an image sensor according to this disclosure.

### DETAILED DESCRIPTION OF EMBODIMENTS

The present disclosure will now be described more fully hereinafter with reference to the accompanying drawings showing embodiments of the disclosure. The disclosure may, however, be embodied in many different forms and should not be construed as limited to the embodiments set forth herein. Rather, these embodiments are provided so that the disclosure will fully convey the scope of the disclosure to those skilled in the art. The drawings are not necessarily drawn to scale but are configured to clearly illustrate the disclosure.

FIG. 1 shows one pixel of an optical sensor according to the principles of the present disclosure. Pixel 110 is a portion of an array of pixels of an optical image sensor 100. The pixel includes a photodiode 111, an access transistor 112 controlled by access signal TX. One of the source/drain diffusion regions of transistor 112 is connected to photodiode 111, the other one of the source/drain regions is connected to the gate of a source follower transistor 132. The source of transistor 132 is connected to a selection transistor 133 which is controlled by selection signal SEL. The drain source path of transistor 133 is connected to a conventional column readout line 120 received by a column selection circuit 121 which provides the signals from a plurality of column signal lines 123 to at least one output line 122 connected to an external terminal.

An extra sensing or extra readout path 114 is capacitively coupled to the floating diffusion node 113 disposed between the source/drain path of access transistor 112 and the gate of source follower transistor 113. The extra signal sensing path 114 is capacitively coupled to the source/drain node as symbolically shown with capacitor 116 so that non-destructive readout of the signal supplied by photodiode 111 is possible when access transistor 112 is enabled. The signal available at floating diffusion node 113 is proportional to the signal provided by photodiode 111 in response to the reception of an optical signal. Photodiode 111 may receive a signal from the optical environment.

The optical signal may change in response to a light change caused, for example, when the optical image sensor is rapidly exposed to environmental light or, for example, in response to a gesture of a human operator or a movement of an object passing by the surface of the optical sensor. A voltage change caused at the floating diffusion node 113 in response to a light change will couple into the extra sensing path 114. The extra sensing path 114 is an extra metal routing disposed in the wiring layer of the image sensor capacitively coupled to the floating diffusion node 113 so that a smart sensor is achieved that enables functions through the extra sensing path such as high dynamic range operation, global light sensing, gesture detection, light fidelity, edge detection or auto wakeup detection.

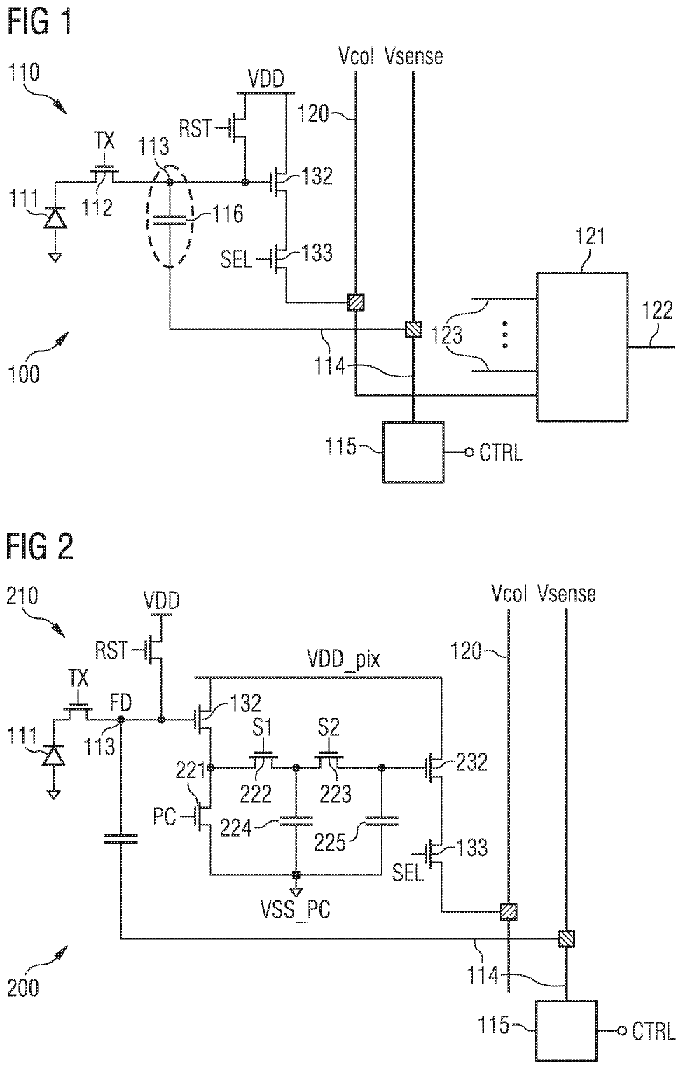

FIG. 2 shows a pixel 210 of an array of pixels of an image sensor 200 configured for global shutter operation of the array. Pixel 210 comprises circuitry to capacitively store the pixel information received at a global shutter instance so that sequential read out is possible. The global shutter pixel includes a precharge transistor 221 receiving precharge signal PC. Selection transistors 222, 223 operated by selection signals S1, S2 are connected between the source follower transistor 132 and another source follower transistor 232. Capacitors 224, 225 connected to the transistors 222, 223 store the signal from photodiode 111 and supply it in time at a readout instance. The signal is stored in capacitor 224 and forwarded to capacitor 225 to enable transistor 232 upon readout.

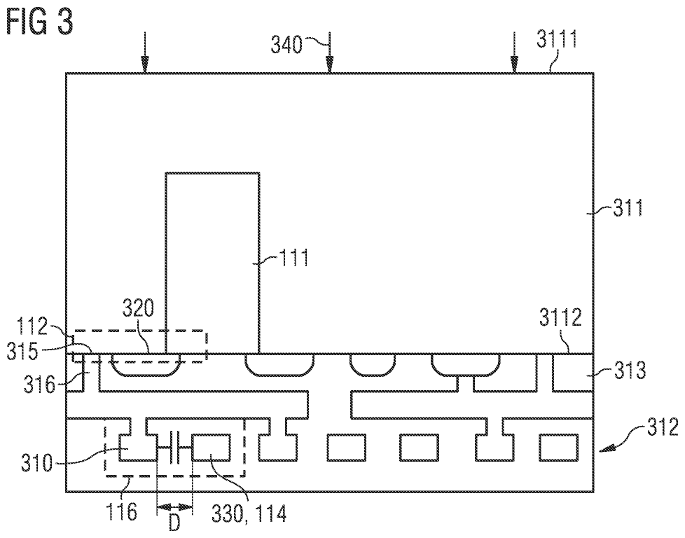

FIG. 3 shows an exemplary cross-section through an integrated circuit carrying a rolling shutter or global shutter pixel showing the floating node diffusion region 113 and the surrounding area. The integrated circuit depicted in FIG. 3 comprises a substrate such as silicon substrate 311 which includes photodiode 111. A light signal 340 is received at the back side 3111 of substrate 311. Photodiode 111 is connected to access transistor 112 which includes a gate terminal 320 that enables transistor 112 to connect photodiode 111 to its drain region 315. A metal plug 316 is connected to the drain region 315 of transistor 112. The metal plug 316 is routed to a metal line 310 disposed in wiring layer 312. Wiring layer 312 includes several metal wires at the same level disposed in a dielectric layer stack 313 disposed on the other main surface 3112 of substrate 311 opposite to back side surface 3111.

The extra readout line 114 is a metal line 330 disposed in metal wiring layer 312. Metal line 330 is disposed in the vicinity to metal line 310 connected to the drain region 315 of access transistor 112 such that metal lines 310, 330 have a sufficient capacitive coupling caused by their neighbourhood relation so that the signal from photodiode 112 such as a voltage change caused by a light change received at photodiode 112 is capacitively coupled into metal line 330 available for readout through extra sensing path 114. The distance D between metal lines 310, 330 to enable capacitive coupling therebetween is at 150 nm or smaller, considering a manufacturing process having a feature size of 90 nm to realize the structures in substrate 311. The distance D may be even smaller, increasing the capacitive coupling in dependence on the minimal reproducible feature size for structures in substrate 311. For example, the distance D may be at or below 110 nm or at or below 90 nm, depending on the actual design parameters.

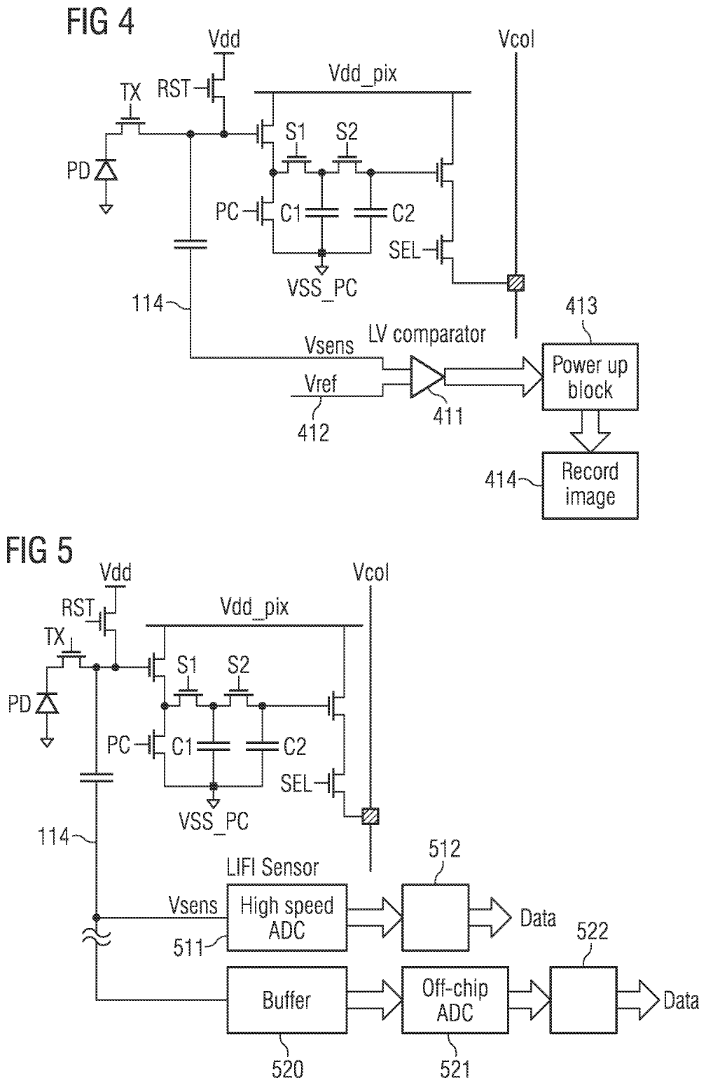

FIG. 4 shows the application of a pixel to perform a power-up operation and the recording of a high quality image in a security application in response to a detected light change. The extra sensing path 114 carrying the capacitively sensed signal Vsens is connected to one terminal of a low voltage (LV) comparator 411. The LV comparator 411 is operated at a reduced voltage lower than the normal operational Vdd of the image sensor. During sensing mode, the supply voltage Vdd can be lower than in high quality operational mode. Examples for operating voltages may be as follows: when normal operation Vdd may be between 2.8 V and 3.3 V, low voltage Vdd applied during extra sensing mode can be between 0.8 V and 1.1 V, respectively. LV comparator 411 receives a reference signal Vref at terminal 412 to detect a light change from low environmental light to brighter environmental light which generates an output signal of comparator 411 that triggers a power-up circuit block 413 which brings the operation of the circuit to high quality operational mode. Immediately thereafter, a high quality image can be recorded as shown in operational block 414. In a security application, when the image sensor detects a change of light, a high quality image can be immediately recorded.

The whole pixel array can be operated as a big photo sense device in that the extra sensing paths 114 connected to a plurality of pixels are coupled together to generate a combined output signal to be evaluated by a comparator. This detects the global light output change from a plurality or all of the pixels of the image array. While the sensor operates in standby mode to detect the global light change, the supply voltage Vdd can be reduced as discussed above.

FIG. 5 shows the application of the pixels of an image array equipped with an extra light sensing path 114 for a LiFi (light fidelity) application. In one embodiment, the extra sensing line 114 is connected to a high speed analog-to-digital converter 511 which generates a digital signal to retrieve the data modulated in the digital signal by a data separator or a data processor 512. ADC 511 and data separator/processor 512 can be realized on the same integrated circuit or, as shown alternatively in FIG. 5, off-chip using a buffer 520 to provide the global sense signal to off-chip ADC 521 and off-chip data separator or off-chip data processor 522 to obtain the data from the received LiFi signal.

In a global sense mode, the extra sensing lines 114 connected to a plurality of pixels may be combined together to generate a global sense signal from a plurality of pixels of the array or all the pixels within the array. The whole pixel array approach operates pixels at the same time to get more stable information, especially for the case when the modulated light is in-sent from any direction. The extra sensing path is used to sense the data package of modulated light globally. The digitalized signals can be rearranged as data package on-chip or can be processed by an extra data processor externally. The LiFi receiver can be designed into an image sensor for short distance data exchange or security check or as a WiFi receiver.

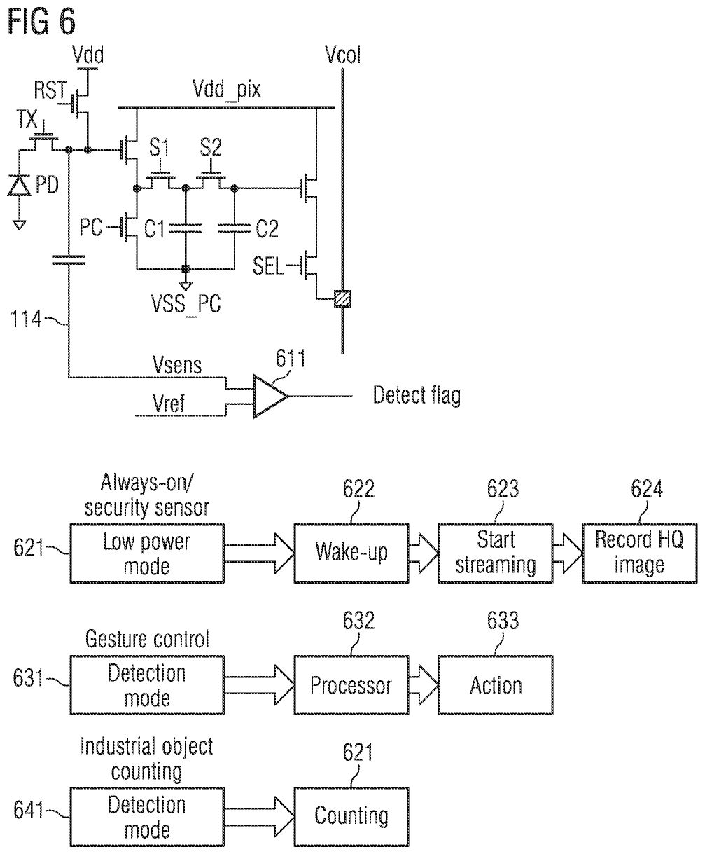

FIG. 6 shows the extra signal sensing path to generate a detect flag in a comparator 611 to control several applications. The detect flag may be used in a security sensor when the image sensor is in low power mode 621 to perform wakeup at 622 in response to the detect flag from comparator 611 and to start streaming at 623 and to record a high quality image at 624. In another application, gesture control is performed at 631 in response to the detect flag to activate a processor at 632 to perform an action at 633. In yet another application, for example in an industrial environment such as a manufacturing line, the detect flag is used in a detection mode 641 to control a counting action 642 for object counting in a manufacturing line of a factory.

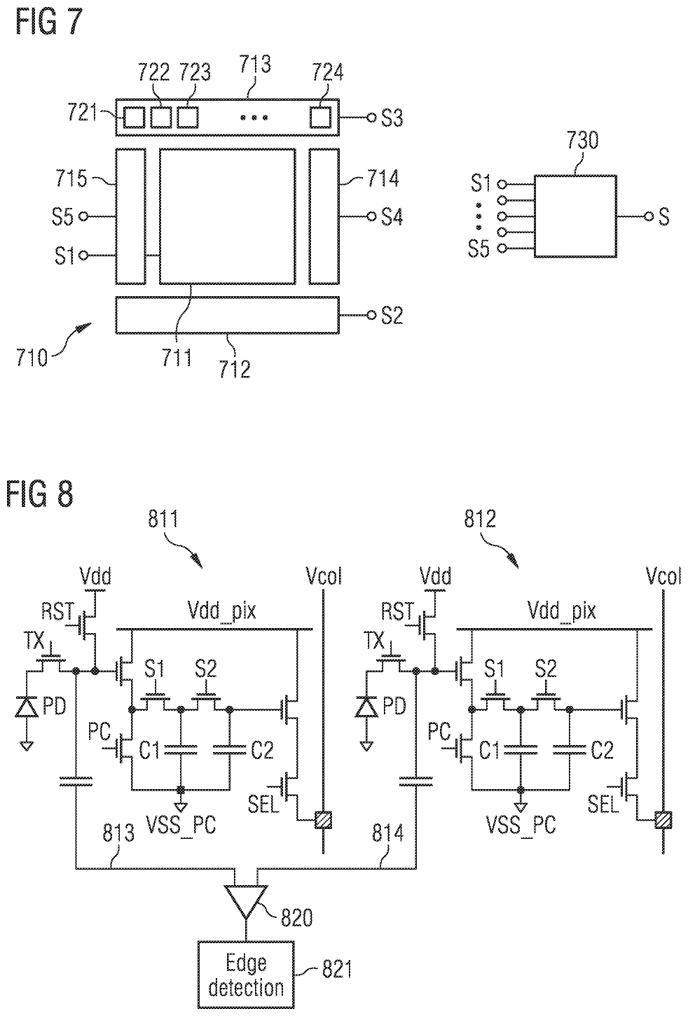

FIG. 7 shows a top view on an image sensor 710. The image sensor comprises five non-overlapping regions 711, 712, 713, 714, 715 each including a plurality of pixels such as 721, 722, 723, 724 of region 713. The extra sensing paths of the pixels within one of the regions are combined to one output sense signal such as signal S3 in case of regions 713. Each one of the other regions comprises one output sense signal which may be the average of the signal sense paths connected to the pixels within the corresponding region such as signal S1 for central region 711, signal S2 for region 712 having an edge disposed in parallel and opposite one of the edges of region 711, signal S3 from region 713 having an edge disposed in parallel and opposite to an edge of region 711 as well as signal S4 from region 714 having an edge disposed in parallel and opposite to an edge of region 711 and signal S5 from region 715 disposed in parallel and opposite an edge of central region 711.

By layout arrangement, the sensing region of the image sensor or the full image sensor is separated into several regions, for example, five blocks such as 711, . . . , 715 arranged in the top, bottom, left, right and middle position. For gesture control applications such as that performed by circuit 730 which receives signals S1, . . . , S5, the left to right movement can be detected from left and right nodes sequentially. Also multi-direction movement can be detected for smart sensors. VR (virtual reality) or AR (augmented reality) applications are also possible. A near-infrared light source may be involved to assist depth detection.

FIG. 8 shows another application of an image sensor using extra sensing paths such as 813, 814 connected to two different pixels 811, 812. Sensing paths 813, 814 are connected to a comparator 820 to perform edge detection as indicated at block 821. A stacking of image information may be useful to realize the edge detection function. Edge detection may be used to perform an image enhancement algorithm on the image information.

The relationship between neighboring pixels is required for image enhancement algorithm input. The extra sensing signal is used for the image enhancement calculation without impact on the image quality, because the sensing output is capacitively coupled to the floating node of a pixel operating non-destructively to the image information.

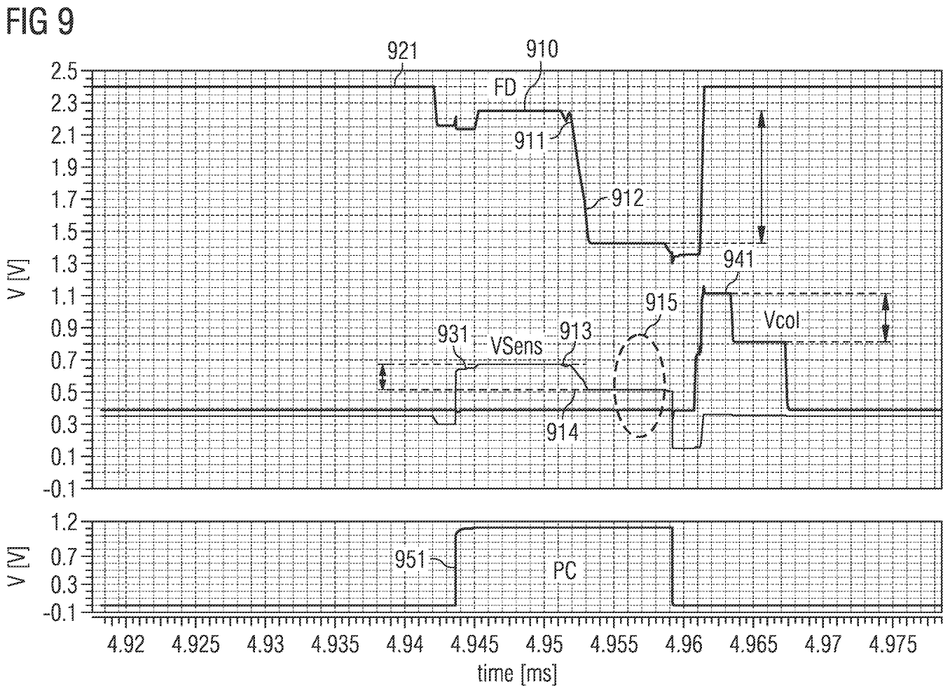

FIG. 9 shows waveforms 931, 931, 941, 951 of exemplary signals FD, Vsense, Vol, PC, resp., taken over time from the pixel of FIG. 2. The floating note 113 is precharged to level 910. When the access transistor 112 becomes conductive at time instant 911, the signal from photodiode 111 is applied to floating node 113 causing a voltage drop 912 of signal FD. The sense signal Vsens is driven to a precharge level 913 approximately at the same time as the floating node precharge is performed. Then the sense signal Vsense drops to level 914 caused by capacitive coupling of sense line 114 to floating node 113. The sense signal Vsense is taken at time instance 915 and output to the evaluation circuit 115 as explained above. Waveform 941 depicts the signal at conventional column readout line 120 and signal 951 depicts the precharge signal PC in the case of the global shutter pixel of FIG. 2. As can be determined from FIG. 9, sense signal Vsens does not destroy the actual high resolution image information of waveform 921.

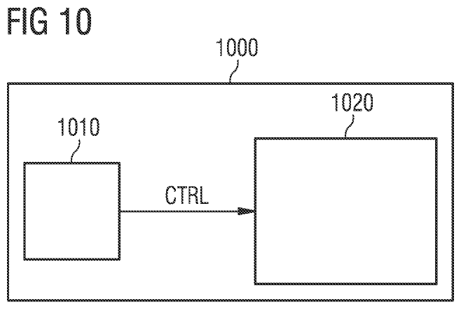

FIG. 10 shows an electronic device 1000 that includes an optical image sensor 1010 described above. Sensor 1010 generates a control signal CTRL forwarded to a processor 1020 to trigger and perform an operation as described above. Processor 120 may control a wakeup operation, an image recording operation for a security application, an action in response to a gesture detection, a counting in response to a movement detection, the processing of data from a stream of data received by the sensor or the enhancement of the contents of an image captured by the optical sensor in response to an edge detection.

In conclusion, the extra sensing process is performed through a special design of a coupling metal to detect the voltage on the floating diffusion node of a pixel. The extra pixel sensing output is proportional to the pixel output and can be a global or a local connection. The global connection reveals an average light intensity sensing of a plurality of pixels. It is a rough light detection so that the pixels can be operated in either normal mode or low supply voltage mode. The output of the extra sensing arrangement can be processed to fit different applications. The global sense mode combines the extra sensing paths of a plurality of pixels throughout the array. The local sensing mode combines the sensing paths within a local region of the array so that several local sensing signals are provided from several regions. The sensing outputs of different regions can be processed with a high speed operation for different purposes. It may be combined with a stacking process to achieve more complex edge detection or image enhancement applications.

It will be apparent to those skilled in the art that various modifications and variations can be made without departing from the spirit or scope of the disclosure as laid down in the appended claims. Since modifications, combinations, sub-combinations and variations of the disclosed embodiments incorporating the spirit and substance of the disclosure may occur to the persons skilled in the art, the disclosure should be construed to include everything within the scope of the appended claims.

1. An optical sensor, comprising:
an array of pixels, each pixel comprising a photodiode configured to receive an optical signal and a floating node coupled to the photodiode;
at least one sensing path capacitively coupled to the floating node of at least one of the pixels;
an evaluation unit coupled to the at least one sensing path to generate an electrical signal dependent on the optical signal received by the photodiode.

2. The optical sensor of claim 1, wherein the at least one of the pixels comprises an access transistor coupled between the photodiode and the floating node, wherein a metal line is connected to a diffusion region of the access transistor and the at least one sensing path is capacitively coupled to the metal line.

3. The optical sensor of claim 2, wherein the at least one sensing path comprises another metal line disposed in vicinity to the metal line connected to the diffusion region of the access transistor to achieve capacitive coupling between the metal line.

4. The optical sensor of claim 3, further comprising:
a semiconductor substrate, the semiconductor substrate including the photodiodes of the pixels of the array of pixels;
at least one metal wiring layer disposed on the semiconductor substrate, the wiring layer comprising the metal line disposed adjacent to each other to achieve capacitive coupling between the metal line and the other metal line.

5. The optical sensor of claim 3, wherein a distance between the metal line and the other metal line is less than 150 nm or less than 110 nm or less than 90 nm.

6. The optical sensor of claim 1, wherein the at least one of the pixels is configured to capacitively couple a voltage change at the floating node to the at least one sensing path.

7. The optical sensor of claim 1, wherein a plurality of pixels are each connected to a respective sensing path, wherein the respective sensing paths connected to the plurality of pixels are coupled to each other to generate a combined or average electrical signal dependent on the optical signals received by the photodiodes of the plurality of pixels.

8. The optical sensor of claim 1, wherein the array of pixels comprises at least two groups of pixels disposed in non-overlapping regions, wherein the at least one sensing path is coupled to the photodiode of a pixel of a first group of pixels and at least another sensing path is coupled to the photodiode of a pixel of a second group of pixels.

9. The optical sensor of claim 8, wherein the array of pixels comprises:
a first group of pixels, the first group of pixels disposed in a rectangular shape;
a second, a third, a fourth and a fifth group of pixels each having a rectangular shape;
wherein the first group of pixels is disposed centrally relative to the second, the third, the fourth and the fifth groups of pixels; and
wherein the second, the third, the fourth and the fifth groups of pixels are disposed in non-overlapping regions surrounding the first group of pixels.

10. The optical sensor of claim 9, wherein in each one of the first, the second, the third, the fourth and the fifth groups of pixels a plurality of sensing paths coupled to a plurality of pixels is combined to one sensing signal representative of each one of the groups of pixels.

11. The optical sensor of claim 1, wherein each one of the pixels further comprises: a source follower transistor having a gate terminal connected to the floating node, a selection transistor coupled between the source follower transistor and a readout line, the readout line connected to a selection circuit receiving several readout lines, the selection circuit configured to provide the electrical signal from the readout lines external to the optical sensor.

12. The optical sensor of claim 11, wherein the evaluation unit comprises a comparator to compare the electrical signal dependent on the optical signal with a threshold signal to detect an environmental light change and to trigger a start-up process to bring the array of pixels from a standby state to a powered-up state.

13. The optical sensor of claim 1, wherein the optical signal comprises a stream of digital data and the evaluation unit comprises an analog-to-digital converter to convert the electrical signal to a digital signal, further comprising a data separation unit or a data processor to retrieve the digital data from the digital signal.

14. The optical sensor of claim 8, wherein the evaluation unit is coupled to the at least one sensing path of the first group of pixels and the at least another sensing path of the second group of pixels and the evaluation unit is configured to perform an edge detection in dependence on the electrical signals received through the at least one and the at least another sensing paths.

15. The optical sensor of claim 9, wherein at least one sensing path is provided by each one of the first, the second, the third, the fourth and the fifth group of pixels, wherein the evaluation unit receives the at least one sensing paths provided by the first, the second, the third, the fourth and the fifth group of pixels, the evaluation unit configured to perform a movement detection or a gesture detection.

16. An electronic device, comprising:
the optical sensor according to claim 1; and
a processor configured to perform a task in response to a control signal generated by the optical sensor, the task being at least one of:
performing wake-up in response to the detection of a light change by the optical sensor;
recording an image in response to the detection of a light change by the optical sensor;
performing an action in response to a gesture detection by the optical sensor;
a counting operation in response to a movement detection by the optical sensor;
the retrieval of data from a stream of data received by the optical sensor; and
the enhancement of the contents of an image in response to an edge detection performed by the optical sensor.

17. An optical sensor, comprising:
an array of pixels, each pixel comprising a photodiode configured to receive an optical signal, a floating node coupled to the photodiode and an access transistor coupled between the photodiode and the floating node;
at least one sensing path capacitively coupled to the floating node of at least one of the pixels; and
an evaluation unit coupled to the at least one sensing path to generate an electrical signal dependent on the optical signal received by the photodiode,
wherein a metal line is connected to a diffusion region of the access transistor and the at least one sensing path is capacitively coupled to the metal line.
